(19) United States
(12) Patent Application Publication
(10) Pub. No.: US 2026/0323518 A1
(43) Pub. Date: Oct. 15, 2026

(54) Configuration for UE Wake Up Signal Triggering SIB1 Transmission and Monitoring

(71) Applicant: Apple Inc., Cupertino, CA (US)

(72) Inventors: Dan Wu, Beijing (CN); Haitong Sun, Saratoga, CA (US); Dawei Zhang, Saratoga, CA (US); Hong He, San Jose, CA (US); Sigen Ye, San Diego, CA (US); Seung Hee Han, San Jose, CA (US); Huaning Niu, San Jose, CA (US); Peng Cheng, Beijing (CN)

(21) Appl. No.: 18/869,236

(22) PCT Filed: Nov. 30, 2023
(86) PCT No.: PCT/CN2023/135385

§ 371 Date: Nov. 25, 2024

(51) Int. Cl. H04W 52/02; H04W 72/23

(52) U.S. Cl. CPC H04W 52/0235; H04W 72/23

(57) ABSTRACT

An apparatus of a user equipment (UE) comprising one or more processors coupled to a memory and configured to decode, at the UE, a wakeup signal (WUS) configuration message received from an anchor cell attached to the UE. A WUS message can be encoded, at the UE, for transmission to a network energy saving (NES) cell to wake up an on-demand system information block 1(SIB1) at the NES cell. A WUS response (WUR) message from the NES cell can be decoded at the UE. The on-demand SIB1 from the NES cell can be decoded, at the UE based on information received in the WUR message.

### FIELD

Embodiments of the invention relate to wireless communications, including apparatuses, systems, and methods for configuring a UE to provide a wake up signal (WUS) triggering SIB1 transmission and monitoring behaviors.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) has been the technology of choice for the majority of wireless network operators worldwide, providing mobile broadband data and high-speed Internet access to their subscriber base. LTE was first proposed in 2004 and was first standardized in Release 8 of the 3^{rd} Generation Partnership Project (3GPP) specifications in 2008. Since then, as usage of wireless communication systems has expanded exponentially, demand has risen for wireless network operators to support a higher capacity for a higher density of mobile broadband users. In 2015, a study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

In Release 18 of the 3GPP specifications, several network energy savings schemes were proposed. In one scheme, a UE can send an uplink wake up signal (WUS) to request transitioning of a cell from no transmission/reception activity, or reduced transmission/reception activity to active transmission or reception of a channel or signal. This allows the cell to maintain a low power level and provide network energy savings until a UE implements communication with the cell. The type of signaling that could be used to implement this action was not determined.

### SUMMARY

Embodiments relate to wireless communications, and more particularly to apparatuses, systems, and methods for an apparatus of a user equpiment, the apparatus comprising one or more processors, coupled to a memory, configured to: decode, at the UE, a wakeup signal (WUS) configuration message received from an anchor cell attached to the UE. A WUS message can be encoded, at the UE, for transmission to a network energy saving (NES) cell to wake up an on-demand system information block 1 (SIB1) at the NES cell. A WUS response (WUR) message from the NES cell can be decoded at the UE. The on-demand SIB1 from the NES cell can be decoded, at the UE based on information received in the WUR message.

The techniques described herein may be implemented in and/or used with a number of different types of devices, including but not limited to unmanned aerial vehicles (UAVs), unmanned aerial controllers (UACs), base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6 illustrates an example of a baseband processor architecture for a UE, according to some embodiments.

FIG. 7 illustrates an example block diagram of an interface of baseband circuitry according to some embodiments.

FIG. 8 illustrates an example of a flow of information blocks between a UE and a next generation Node B (gNB) in accordance with some embodiments.

FIG. 9 illustrates an example of ANSI C code illustrating information communicated in a master information block (MIB) in accordance with some embodiments.

FIG. 10 illustrates an example of a UE that is in communication with an anchor gNB and a gNB in a cell that is configured for network energy savings (NES) in accordance with some embodiments.

FIG. 11 illustrates an example of messaging used to establish an on-demand SIB1 in an NES cell that includes a gNB configured for the NES cell in accordance with some embodiments.

FIG. 12 illustrates an example of information comprising a DCI field 1200 of a DCI format 1_x, where x is zero or a positive integer in accordance with some embodiments.

FIG. 13 illustrates an example of a random access response (RAR) medium access control (MAC) physical data unit (PDU) in accordance with some embodiments.

FIG. 14 illustrates an example of a MAC RAR in accordance with some embodiments.

FIG. 15 illustrates an example of a MAC sub-PDU in accordance with some embodiments.

FIG. 16 illustrates an example of a MAC wakeup signal response (WUR) that includes a SIB1 monitoring indication in accordance with some embodiments.

FIG. 17 illustrates an example of a MAC WUR that additionally includes a synchronization signal block (SSB) index in accordance with some embodiments.

FIG. 18 illustrates a MAC WUR that additionally includes SSB bitmaps in accordance with some embodiments.

FIG. 19 illustrates an example of a MAC WUR that additionally includes an SSB positions in burst in one group, and an SSB positions in burst group presence in accordance with some embodiments.

FIG. 20 illustrates an example flow chart of a method of triggering an on-demand SIB1 transmission to a UE, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. 5G NR can support scalable channel bandwidths from 5 MHz to 100 MHz in Frequency Range 1 (FR1) and up to 400 MHz in FR2. In other radio access technologies, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

SIB1—In 5G New Radio (NR), the System Information Block Type 1 (SIB1) is a critical and dedicated information block that is broadcasted by the base station (gNB) to provide essential system parameters and configuration information to the user equipment (UE) or devices in the network coverage area.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

The example embodiments may be further understood with reference to the following description and the related appended drawings, wherein like elements are provided with the same reference numerals. The example embodiments relate to configurations for a UE WUS that triggers a SIB1 transmission in a cell, thereby creating an on-demand SIB1, and monitoring behaviors for the UE to monitor the on-demand SIB1 transmission.

The example embodiments are described with regard to communication between a next generation Node B (gNB) and a user equipment (UE). However, reference to a gNB or a UE is merely provided for illustrative purposes. The example embodiments may be utilized with any electronic component that may establish a connection to a network and is configured with the hardware, software, and/or firmware to support on-demand SIB1 triggering and monitoring. Therefore, the gNB or UE as described herein is used to represent any appropriate type of electronic component.

The example embodiments are also described with regard to a fifth generation (5G) New Radio (NR) network that may configure a UE to control the WUS triggering to activate the SIB1. However, reference to a 5G NR network is merely provided for illustrative purposes. The example embodiments may be utilized with any appropriate type of network.

Throughout this description various information elements (IEs) are referred to by specific names. It should be understood that these names are only examples and the IEs carrying the information referred to throughout this description may be referred to by other names by various entities.

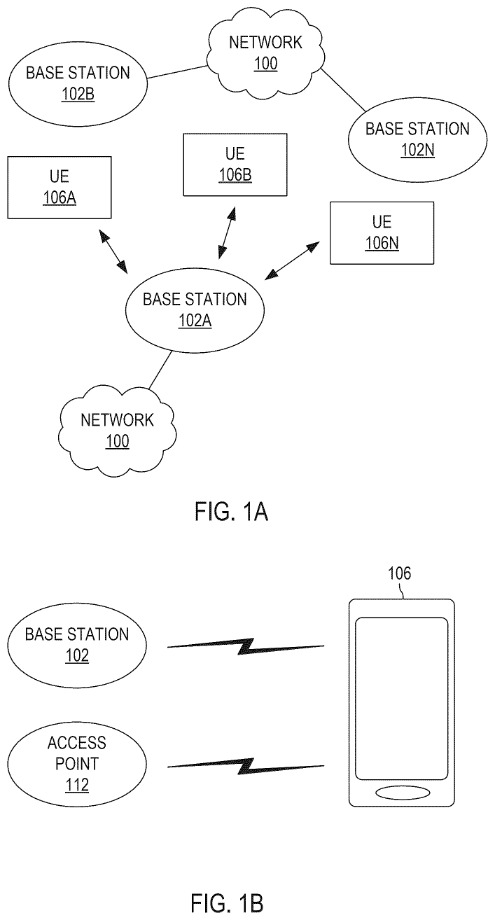

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP 2 CDMA2000 (e.g., 1xRTT, 1xEV-DO, HRPD, eHRPD), etc. Note that if the base station 102A is implemented in the context of LTE, also referred to as the Evolved Universal Terrestrial Radio Access Network (E-UTRAN, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA 2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

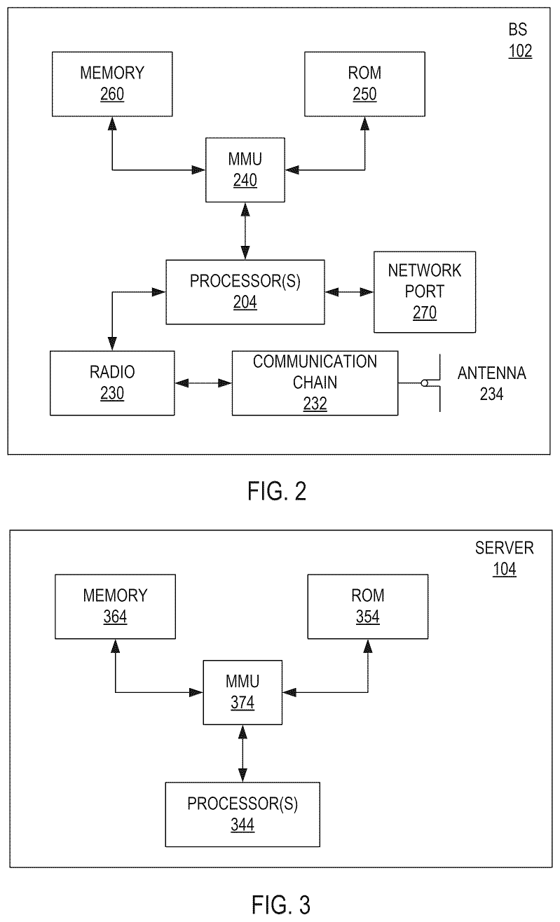

### FIG. 2: Block Diagram of a Base Station

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

In some embodiments, the base station or gNB 102, and/or processors 204 or 604 thereof, can be capable of encoding a wakeup signal configuration message for transmission from an anchor gNB to a UE.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, and UE devices 106 access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

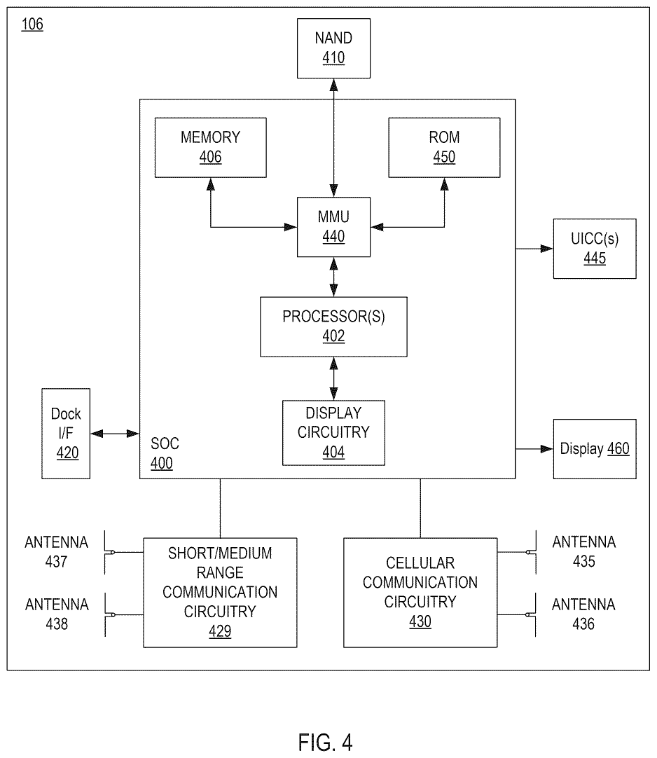

### FIG. 4: Block Diagram of a User Equipment

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMS may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VOLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

In some embodiments, the UE 106 and/or the processors 402 and 604 thereof can be configured to and/or capable of encoding a wakeup signal for transmission from a UE to a network energy savings cell gNB, as described herein.

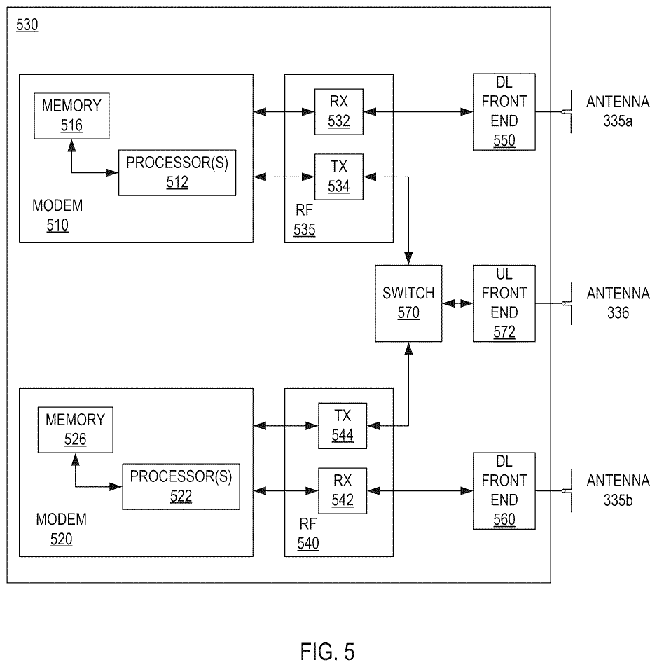

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 535. RF front end 535 may include circuitry for transmitting and receiving radio signals. For example, RF front end 535 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 535, 550, 570, 572, 335a, 335b, and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335a, 335b, and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

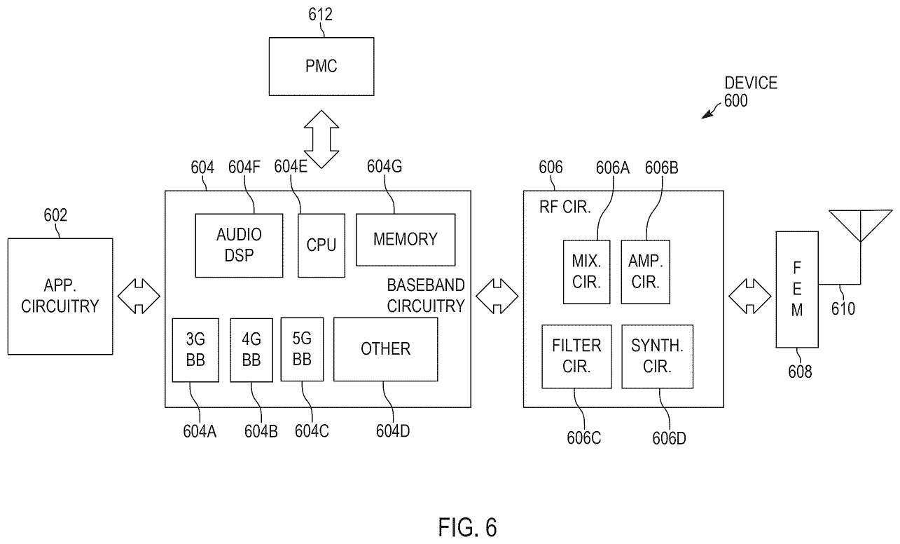

### FIG. 6: Block Diagram of a Baseband Processor Architecture for a UE

FIG. 6 illustrates example components of a device 600 in accordance with some embodiments. It is noted that the device of FIG. 6 is merely one example of a possible system, and that features of this disclosure may be implemented in any of various UEs, as desired.

In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE 106 or a RAN node 102A. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuity 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a necessity. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional−N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a necessity. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter. FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604, in other embodiments the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in a radio resource control_Connected (RRC_Connected) state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it will transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used execute Layer 3, Layer 2, or Layer 1 functionality, while processors of the application circuitry 604 may utilize data (e.g., packet data) received from these layers and further execute Layer 4 functionality (e.g., transmission communication protocol (TCP) and user datagram protocol (UDP) layers). As referred to herein, Layer 3 (L3) may comprise a radio resource control (RRC) layer, described in further detail below. As referred to herein, Layer 2 (L2) may comprise a medium access control (MAC) layer, a radio link control (RLC) layer, and a packet data convergence protocol (PDCP) layer, described in further detail below. As referred to herein, Layer 1 (L1) may comprise a physical (PHY) layer of a UE/RAN node, described in further detail below. Accordingly, the baseband circuitry 604 can be used to encode a message for transmission between a UE and a gNB, or decode a message received between a UE and a gNB.

For example, the baseband circuitry 604 can be used to encode, at the NES gNB, a wakeup response message (WUR). In another embodiment, the baseband circuitry 604 can be used to decode, at the UE, the WUR message, to enable the UE to monitor an on-demand SIB 1 message. These examples are not intended to be limiting. The baseband circuitry can be used as previously described.

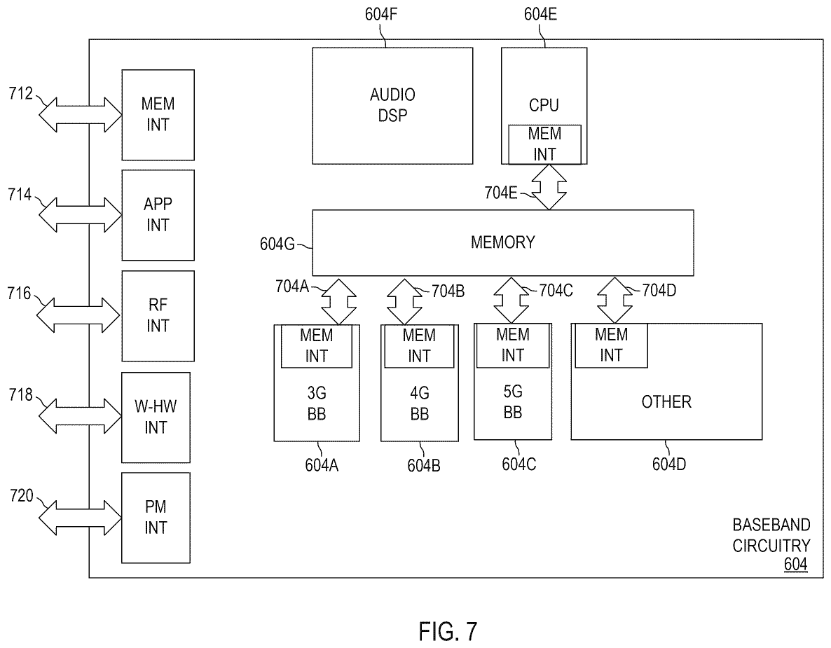

### FIG. 7: Block Diagram of an Interface of Baseband Circuitry

FIG. 7 illustrates example interfaces of baseband circuitry in accordance with some embodiments. It is noted that the baseband circuitry of FIG. 7 is merely one example of a possible circuitry, and that features of this disclosure may be implemented in any of various systems, as desired.

As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 714 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

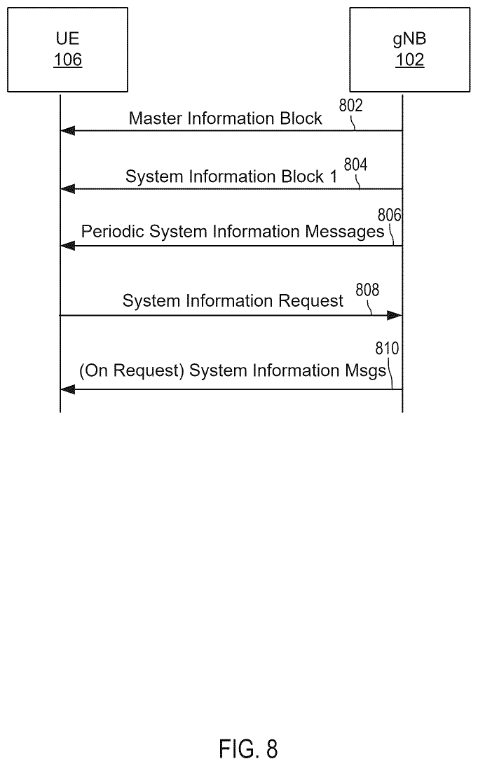

### FIGS. 8-19: Background and On-demand SIB1

Network energy saving is of great importance for environmental sustainability, to reduce environmental impact (greenhouse gas emissions), and for operational cost savings. As 5G is becoming pervasive across industries and geographical areas, handling more advanced services and applications requiring very high data rates, networks are being constructed that are denser, use more antennas, larger bandwidths and higher frequency bands that have greater atmospheric attenuation. The environmental impact of 5G needs to stay under control, and novel solutions to improve network energy savings need to be developed.

Energy consumption has become a key part of a network operators' operating expense. According to one report, the energy cost on mobile networks accounts for approximately 23% of the total operator cost. Most of the energy consumption comes from the radio access network (RAN) and in particular from the Active Antenna Unit (AAU), with data centers and fiber transport accounting for a smaller share. The power consumption of a radio access can be split into two parts: the dynamic part which is only consumed when data transmission/reception is ongoing, and the static part which is consumed all the time to maintain the necessary operation of the radio access devices, even when the data transmission/reception is not on-going.

Therefore, a key saving area is to reduce the amount of time that data transmission/reception is ongoing in the RAN. In releases prior to 3GPP Release 18, the specifications were typically developed to minimize the power consumption at the UE, often with disregard to the amount of power used at the gNB or network. While power consumption at the UE is a main concern, due to the limitations of power provided by batteries for mobile UEs, the design and operation of the RAN can be implemented to reduce the amount of time that the RAN is actively transmitting and receiving. This can enable a more efficient operation dynamically and/or semi-statically and finer granularity adaptation of transmissions and/or receptions in one or more of network energy saving techniques in time, frequency, spatial, and power domains. With potential support and feedback from the UE, potential UE assistance information, and information exchange/coordination over network interfaces, the design of the RAN can be improved to reduce power usage at the RAN and provide real cost savings to network operators while limiting the effects of the RAN's power consumption on the environment.

NR RANs are configured to transmit two types of system information blocks (SIBs). One type is transmitted periodically, while the other type is only transmitted when there is a request from a UE. FIG. 8 illustrates an example of the flow of information blocks between the UE 106 and the gNB 102. When a UE 106 is powered on, it first performs a cell search and decodes the master information block (MIB) that is broadcast 802 by the gNB 102 to the UE 106.

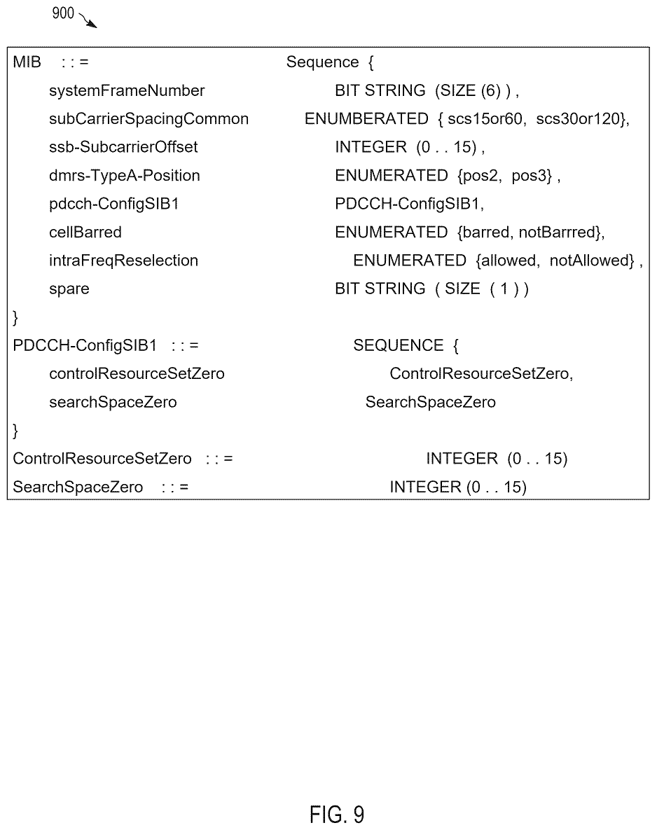

In one example, a MIB can be broadcast with a selected periodicity, such as 80 milliseconds (ms). FIG. 9 provides an example of ANSI C code illustrating information communicated in a MIB 900. The MIB 900 includes parameters that are used to decode the System Information Block Type 1 (SIB1), including the system frame number, the subcarrier spacing (SCS), the subcarrier offset of the synchronization signal physical broadcast channel block (SSB), the position of the first downlink demodulation reference signal (DMRS). The pdcchConfigSIB1 includes the bandwidth for the physical downlink control channel (PDCCH)/system information block (SIB), a common control resource set (CORESET), a common search space (SS) and selected PDCCH parameters. The common CORESET and SS are typically referred to as CORESET #0 and SS #0.

Returning to FIG. 8, using parameters received in the MIB 900, the UE can attempt to decode the SIB1 that is transmitted 804 by the gNB 102 to the UE 106. The SIB1 includes information regarding periodic SIBs 806 and on-request 810 SIBs that can be sent from the gNB 802 to the UE 106. The on request SIBs are sent based on a system information request 808 sent from the UE 106 to the gNB 102.

In the 3GPP 5G New Radio (NR) specification, the System Information Block Type 1 (SIB1) is a critical and dedicated information block that is broadcast by the base station (gNB) to provide system parameters and configuration information to the user equipment (UE) or devices in the network coverage area of the cell that the gNB 102 is located in. The periodic broadcasting of the SIB1 by the gNB can consume a relatively large amount of power. The SIB1 is transmitted in a downlink shared channel, such as the physical downlink shared channel (PDSCH) as downlink control information. There is a complicated procedure for the gNB to transmit the DCI to the UE that is beyond the scope of this description. Typically, the DCI is transmitted with a periodicity of 160 milliseconds and within the 160 ms period, repetitive transmission can occur. The SIB1 includes information regarding the availability and scheduling of other SIBs, thereby enabling the UE to determine whether the other SIBs (e.g. predefined SIBs 2 to 21) are received via a periodic broadcast, or are on-demand. If the SIBs are on-demand, then the SIB 1 includes information about Accordingly, it is typically necessary for the UE 106 to receive and decode the SIB1 in order to proceed in communicate with the gNB 102 in a cell.

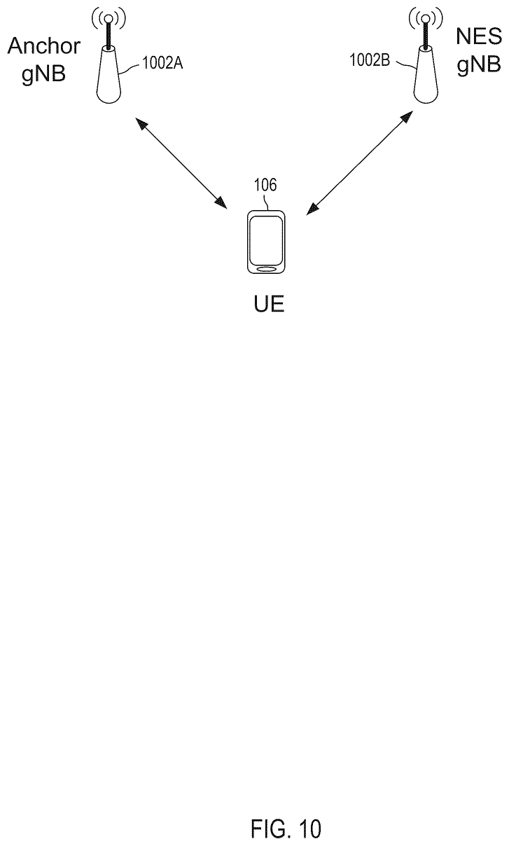

FIG. 10 provides an example illustration of a UE 106 that is in communication with an anchor gNB 1002A and a gNB 1002B in a cell that is configured for network energy savings (NES). In some embodiments, rather than broadcasting the SIB1 at a frequent interval, cells that are configured for NES can have a gNB 1002B that is configured to transmit the SIB1 only when it is requested by a UE 106. In other words, the SIB1 can be configured to be on-demand in NES cells. A UE can be configured to trigger the on-demand SIB1 from the NES cell using a wake up signal (WUS). This can significantly reduce the amount of power used at the gNB in an NES cell.

In some embodiments, a WUS configuration can be obtained by the UE from an anchor gNB 1002A of the UE 106. The control resource set #0 (CORESET #0), search space #0 configurations, and physical downlink control channel (PDCCH) monitoring behavior of the UE after sending the WUS, will be further described in the proceeding paragraphs.

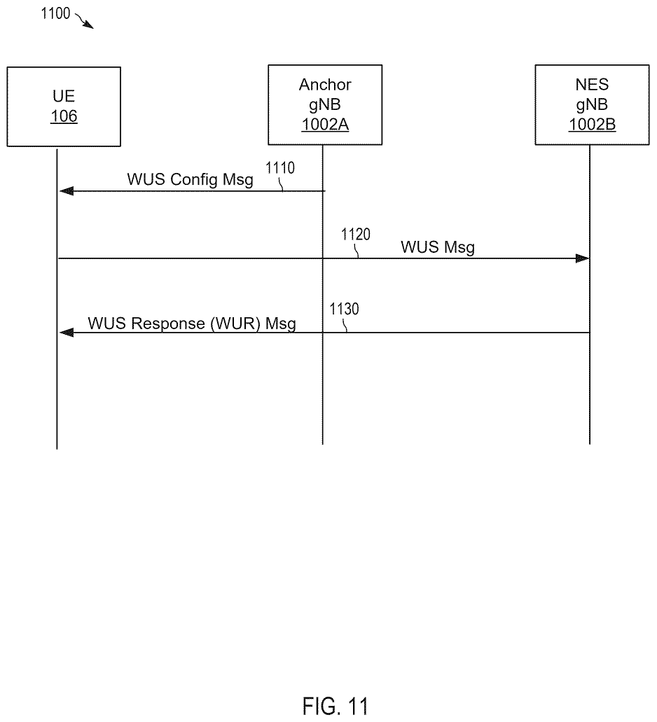

FIG. 11 provides an example of messaging 1100 used to establish an on-demand SIB1 in an NES cell that includes a gNB configured for the NES cell, also referred to as an NES gNB 1002B. An anchor cell can include an anchor gNB 1002A. The anchor gNB 1002A may be already attached to the UE 106.

In some embodiments, the anchor gNB 1002A can prepare and encode 1110 a WUS configuration message, using a baseband processor, such as processor 604d, and one or more additional processors, such as processor 204, for transmission of the WUS configuration message using Radio Frequency (RF) circuitry 606, front-end module (FEM) circuitry 608, and one or more antennas 610 from the anchor gNB 1002A to the UE 106.

The WUS configuration message can comprise time, frequency and sequence resources and power related parameters for the UE 106 to transmit the WUS to the NES gNB 1002B. The WUS configuration message can also include configuration information for a WUS Response Window, a WUS Response CORESET, and a WUS Response Search Space, with the parameters either predefined in the 3GPP specification or configured by the anchor gNB 1002A.

A legacy physical random access channel (PRACH) preamble and random access procedure can be considered as a baseline for a WUS message 1120 and procedure communicated from the UE 106 to the NES gNB 1002B. One or multiple preambles can be configured as on-demand SIB1 WUS preambles. Typically, a single preamble is sufficient. The network may only need to monitor one preamble on a WUS occasion. However, multiple preambles may be used to provide some separability of UEs according to different UE capabilities or to convey more information at the WUS triggering state. For example, different levels of system information blocks (SIBs) may be requested.

After sending the WUS message, the UE can begin a PDCCH monitoring window to monitor a WUS response message 1130 sent from the NES gNB 1002B to the UE 106. The downlink control information (DCI) and content of the WUS response will be further discussed in the proceeding paragraphs, along with on-demand SIB1 monitoring behaviors.

In some embodiments, a CORESET #0 and a search space #0 (SS #0) can be provided by the gNB 1002B in an NES cell in the DCI content of the WUS response message 1130. A new DCI field, which can be referred to in one example as a PDCCH-ConfigOnDemandSIB1 message, can be scrambled with a random access (RA) radio network temporary identifier (RA-RNTI) or a WUS-RNTI.

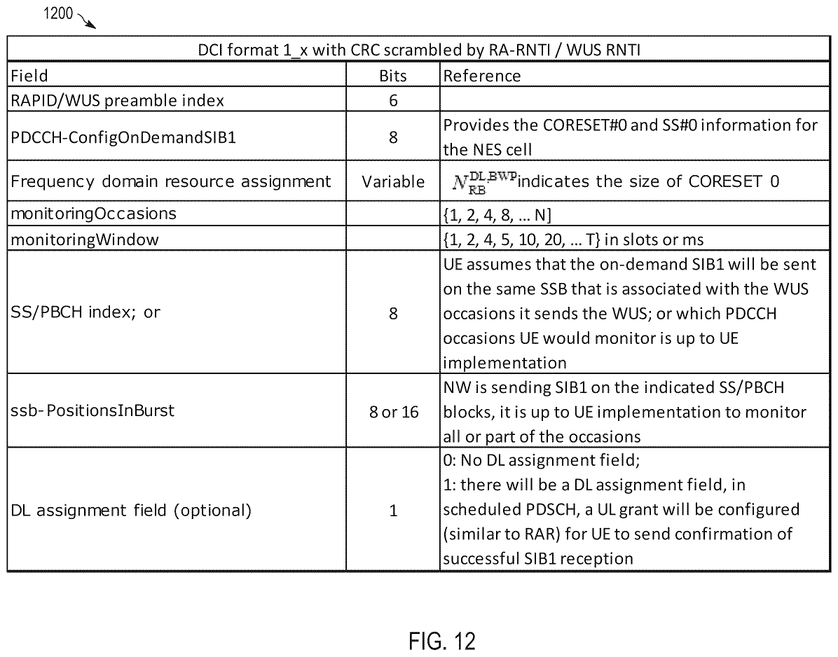

FIG. 12 includes an example of information comprising a DCI field 1200 of a DCI format 1_x, where x is zero or a positive integer. The DCI field can be scrambled by a RA-RNTI or a WUS-RNTI. The WUS-RNTI is a radio network temporary identifier that is associated with the wake up signal. The DCI field 1200 can include, but is not limited to the following information. A Random Access Preamble Identification (RAPID) preamble index or a WUS preamble index comprising 6 bits. A physical downlink control channel (PDCCH) configuration on demand SIB1 (PDCCH-ConfigOnDemandSIB 1) comprising 8 bits. The PDCCH-ConfigOnDemandSIB1 can provide the CORESET #0 and the SS#0 information for the NES cell with the NES gNB 1002B, with similar functionality as the PDCCHCONFIGSIB1 in the MIB 900 illustrated in FIG. 9. The DCI field 1200 can further comprise reserved bits.

In some embodiments, the DCI field 1200 can use an existing DCI format 1_0, where x=0. If the cyclic redundancy check (CRC) of the DCI format 1_0 is scrambled by RA-RNTI/WUS-RNTI and the “frequency domain resource assignment” field are all ones, then the DCI_format 1_0 can be for on-demand SIB 1 transmission with the above fields that are illustrated in FIG. 12. Alternatively, there can be a new DCI format that use the above fields.

The UE 106 can start monitoring the DCI format 1_0 with CRC scrambled by system information (SI) RNTI in a search space #0 (SS #0) from a first physical downlink control channel (PDCCH) occasion after the DCI field is detected and the RAPID preamble index or the WUS preamble index matches a preamble index selected at the UE for transmission

The DCI field 1200 can further comprise a frequency domain resource assignment, with a variable number of bits, wherein N_{RB}^{DL,EWP} indicates the size of CORESET 0 in resource blocks for a downlink bandwidth part (BWP).

The DCI field 1200 can further comprise a field indicating a number of occasions or duration for the UE to monitor search space #0 (SS #0). The monitoring occasions can include 1, 2, 4, 8, . . . N occasions. A monitoring window can include 1,2, 4, 5, 10, 20 . . . T in slots or milliseconds (ms). Otherwise, if there is no explicit window configured, it can be left up to UE implementation to monitor the DCI.

The DCI field 1200 can further comprise a field containing a synchronization signal physical broadcast channel index (SSB index), comprising 8 bits that can be optionally included. The UE 106 can be configured to assume that the on-demand SIB1 will be sent on a same SSB that is associated with the WUS occasions that sends the WUS. Alternatively, which PDCCH occasions that the UE would monitor can be up to UE implementation.

If the SSB index is included, the UE 106 can follow the indication to monitor the corresponding PDCCH occasion. The SIB1 communicated from the NES gNB 1002B in the NES cell can be sent on the indicated SS/PBCH block,

The DCI field 1200 can further comprise an SSB positions in burst (SSB-PositionsInBurst), comprising 8 or 16 bits. It can be left up to UE implementation to monitor all or part of the occasions.

The DCI field 1200 can further comprise a field comprising 1 bit and indicating whether a downlink assignment field is configured. In one example, a “O” can indicate that there is no downlink assignment field. A “1” can indicate that there will be a downlink assignment field in a scheduled physical downlink shared channel (PDSCH). An UL grant can be configured (similar to a random access response (RAR)) for the UE 106 to send confirmation of a successful SIB 1 reception.

In some embodiments, the DCI field 1200 can use an existing DCI format 1_0, where x=0. If the cyclic redundancy check (CRC) of the DCI format 1_0 is scrambled by RA-RNTI/WUS-RNTI and the “frequency domain resource assignment” field are all ones, then the DCI_format 1_0 can be for on-demand SIB 1 transmission.

In some examples, a MAC PDU can be used to configured the CORESET #0 and the SS #0 for the NES gNB 1002B in the NES cell. A MAC PDU is a bit string that is byte aligned (i.e. multiple of 8 bits) in length. A MAC PDU consists of one or more MAC subPDUs. Each MAC subPDU consists of one of the following:
a MAC subheader only (including padding);
a MAC subheader and a MAC SDU;
a MAC subheader and a MAC CE; or
a MAC subheader and padding.

The MAC SDUs are of variable sizes. A maximum of one MAC PDU can be transmitted per transport block (TB) per MAC entity.

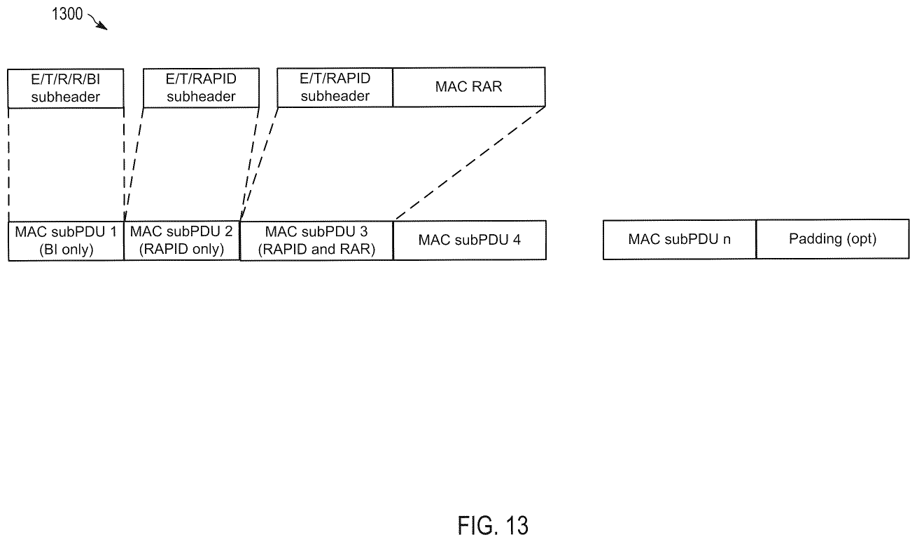

FIG. 13 provides an example illustration of a random access response (RAR) MAC PDU 1300. A scheduled TB can include the RAR MAC PDU 1300, that comprises one or more subPDUs. Each MAC subPDU comprises one of the following:
a MAC subheader with Backoff indicator only;
a MAC subheader with RAPID only (i.e. acknowledgement for an SI request);
A MAC subheader with RAPID and MAC RAR.

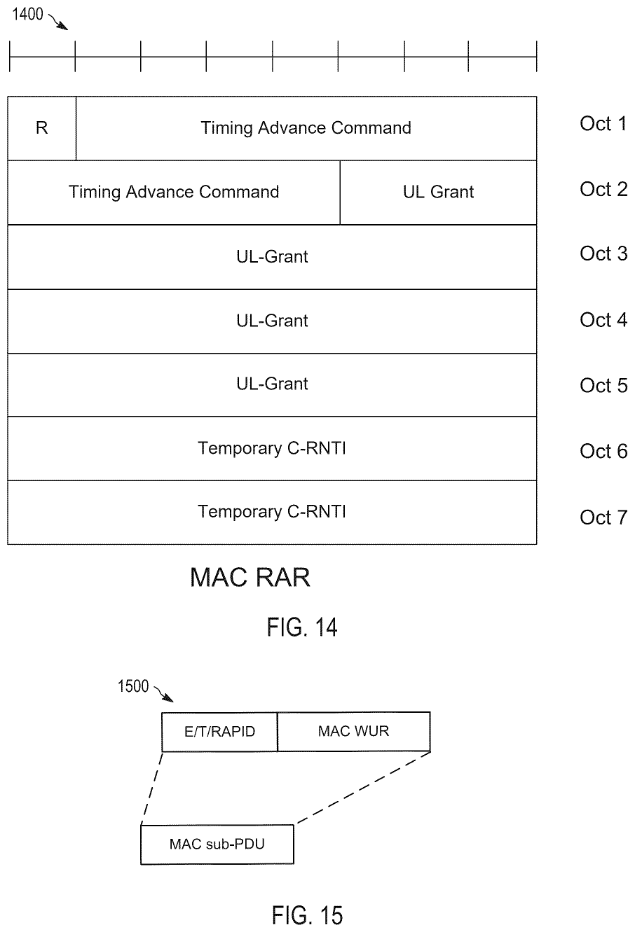

FIG. 14 provides an example illustration of a MAC RAR 1400. The MAC RAR can be of fixed size and comprises:
R: Reserved bit, set to 0;
Timing Advance Command: 12 bits;
UL Grant: 27 bits;
Temporary C-RNTI: 16 Bits.

In some examples, a new MAC sub-PDU can be introduced to configure the CORSET #0 and the SS #0 for the NES gNB 1002B in the NES cell. An example of the MAC sub-PDU 1500 is illustrated in FIG. 15. The new sub-PDU can comprise a MAC sub-header with a RAPID/WUS ID and a MAC WUS Response (WUR). The MAC sub-header can remain as a legacy E/T/RAPID (or WUS ID). The MAC WUR can at least include the CORESET #0 and the SS #0 configuration using 8 bits.

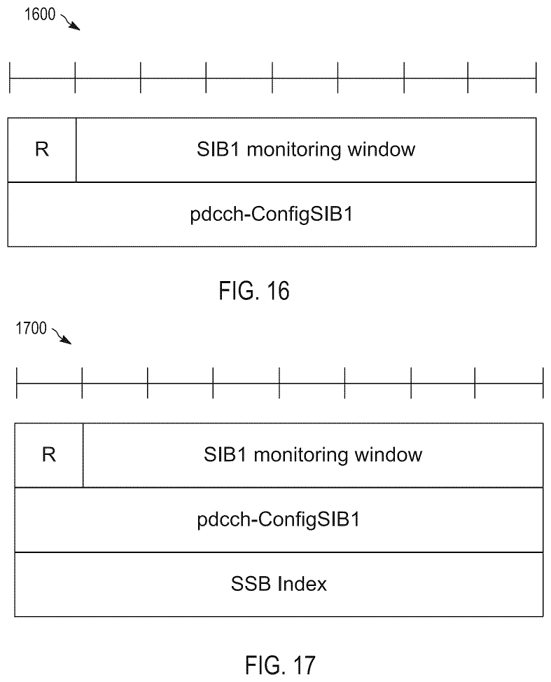

FIG. 16 provides an example of a MAC WUR 1600 that includes a SIB1 monitoring indication. A monitoring occasion or window can be additionally defined for the on-demand SIB 1 using the MAC WUR 1600. If the monitoring Occasions/monitoring Window field is configured, the UE can follow the indication for the monitoring duration. Otherwise, when there is no explicit window configured, it can be up to UE implementation to monitor.

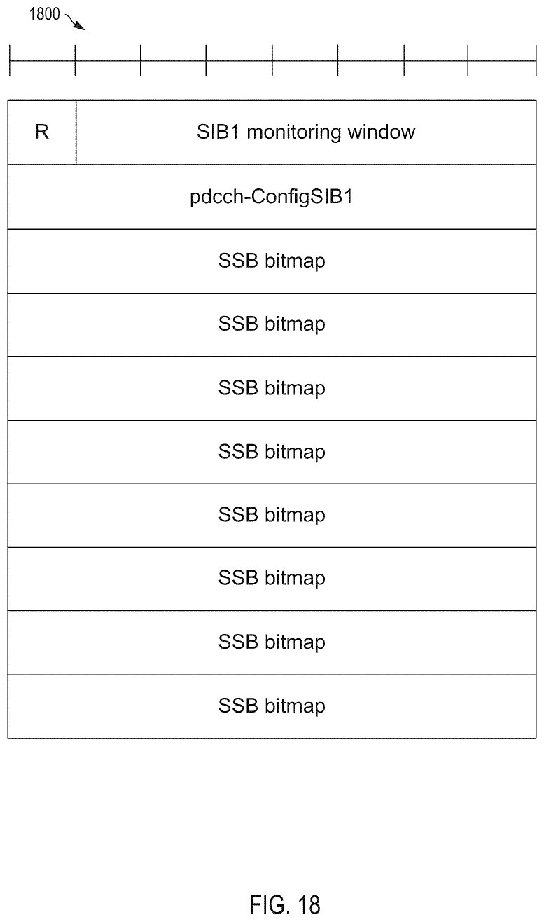

FIG. 17 provides an example of a MAC WUR 1700 that additionally includes an SSB index. FIG. 18 provides an example of a MAC WUR 1800 that additionally includes SSB bitmaps or a group bitmap. The SSB information in the index and bitmaps can indicate the SSBs that will be associated with an on-demand SIB1. The UE can then monitor these SSBs. If the SSB index and bitmaps are not configured, then the UE can assume that the on-demand SIB 1 will be sent on the same SSB that is associated with the WUS occasions that the UE sends. Alternatively, if the SSB index and bitmaps are not configured, it can be up to UE implementation to determine which PDCCH occasions the UE will monitor.

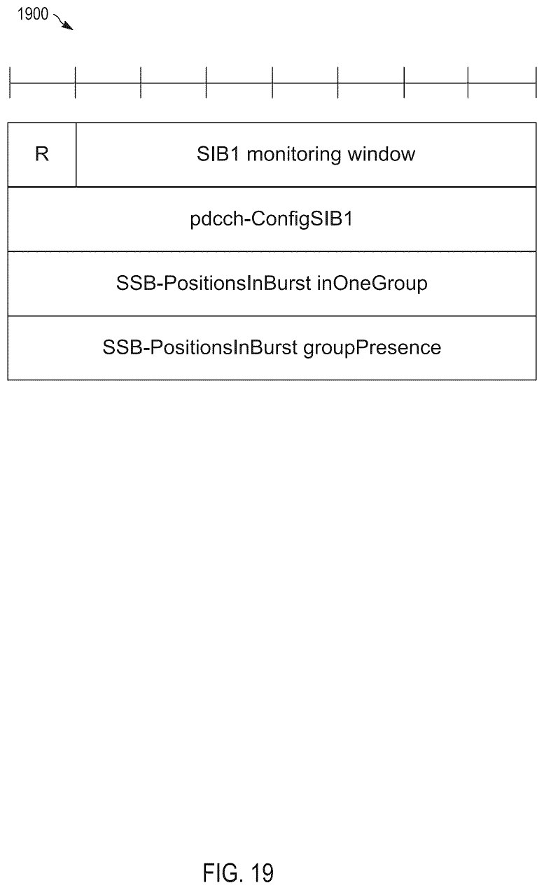

FIG. 19 provides an example of a MAC WUR 1900 that additionally includes an SSB positions in burst in one group, and an SSB positions in burst group presence. As in the DCI design, If ssb-PositionsInBurst (similar structure, 8 or 16 bits) is included, it means that the NW is sending SIB1 on the indicated SS/PBCH blocks. It can be up to UE implementation to monitor all or part of the occasions. The SSB positions in burst group presence can be used for frequency range 2 (FR2).

In some examples, no CORSET #0 and SS #0 may be provided. The following alternatives can be considered. SIB1 can be scheduled in a WUS response. In one example, an on-demand SIB1 can be directly provided in the scheduled TB of the PDCCH that is scrambled with a RA-RNTI or a WUS-RNTI. Alternatively, a new MAC WUR can be defined to carry the on-demand SIB1.

When there are only a few UEs (i.e. tens of UEs or less), the network can be configured to send the SIB1 once for a UE to connect. When the number of UEs is increased, it can be more beneficial to periodically broadcast the SIB1 as is done in legacy. Accordingly, the configuration of the CORESET #0 and SS #0 is needed. In one embodiment, the DCI can be used to indicate which mode is used. The one-time SIB1 transmission, or a broadcast SIB1 transmission.

In some examples, a field in DCI format 1_x can be introduced with the CRC scrambled with RA-RNTI or WUS RNTI to indicate whether the on-demand SIB1 is a one-time transmission or a periodic broadcast SIB1. The field can comprise:
0: Periodic broadcast SIB1, DCI, such as the example DCI of FIG. 12 can be used.
1: One-time transmission of SIB 1. The SIB1 can be provided in the scheduled TB of the PDCCH or within a new MAC WUR defined to carry the on-demand SIB1, as previously described.

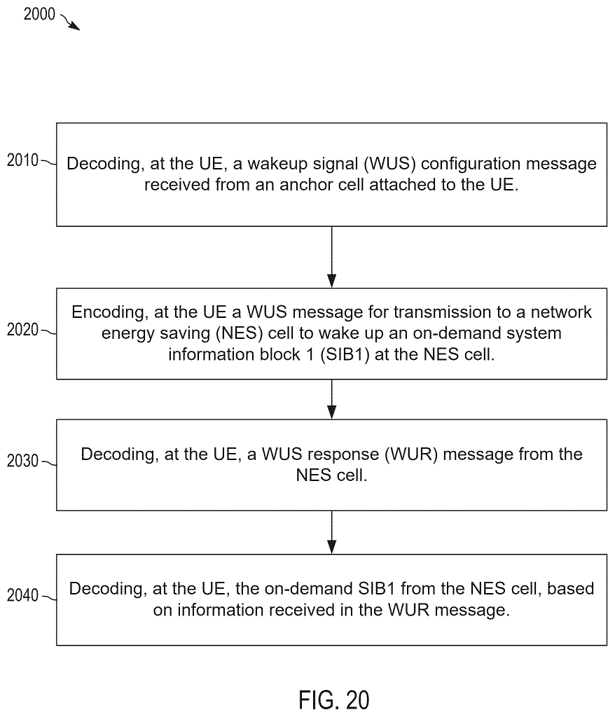

### FIG. 20: Flow Chart for a Method of Triggering an On-Demand SIB1 Transmission to a UE

FIG. 20 illustrates a flow chart of an example of a method of triggering an on-demand SIB1 transmission to a UE, according to some embodiments. The method shown in FIG. 20 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, a method 2000 triggering an on-demand SIB1 transmission to a UE is disclosed. The method 2000 comprises decoding, at the UE, a wakeup signal (WUS) configuration message received from an anchor cell attached to the UE, as shown in block 2010. The method further comprises encoding, at the UE a WUS message for transmission to a network energy saving (NES) cell to wake up an on-demand system information block 1 (SIB1) at the NES cell, as shown in block 2020. The method further comprises decoding, at the UE, a WUS response (WUR) message from the NES cell, as shown in block 2030. The method additionally comprises decoding, at the UE, the on-demand SIB1 from the NES cell, based on information received in the WUR message, as shown in block 2040.

In some embodiments, the WUS configuration message comprises: time, frequency, and sequence resources for the UE to transmit the WUS message; and configuration information for a WUS-response window, a WUS-response control resource set (CORESET), and WUS-response search space.

In some embodiments, the method 2000 further comprises decoding, at the UE, one or more on-demand SIB1 WUS preambles associated with the on-demand SIB1.

In some embodiments, the method 2000 further comprises starting a physical downlink control channel (PDCCH) monitoring window, after sending the WUS message, to monitor the WUS response. A configuration can be decoded, at the UE, for a control resource set #0 (CORESET #0) and a search space #0 (SS #0) in downlink control information (DCI) of the WUR message received from the NES cell.

In some embodiments, the method 2000 further comprises decoding, at the UE, downlink control information (DCI) in a DCI format 1_x, where x is zero or a positive integer, and the DCI includes a scrambled cyclic redundancy check (CRC). The CRC can be scrambled with a random access (RA) radio network temporary identifier (RA-RNTI) or a WUS-RNTI. The DCI can comprise a DCI field including one or more of: a Random Access Preamble identification (RAPID) preamble index or a WUS preamble index; or a physical downlink control channel (PDCCH) configuration on demand SIB1 (PDCCH-ConfigOnDemandSIB1); or reserved bits; or a field indicating a number of occasions or duration for the UE to monitor search space #0 (SS #0); or a field containing a synchronization signal physical broadcast channel index (SSB index) or an SSB positions in burst (SSB-PositionsInBurst); or a field indicating whether a downlink assignment field is configured.

In some embodiments, the method 2000 further comprises starting monitoring the DCI field with a CRC scrambled by a system information (SI) RNTI in a search space #0 (SS #0) from a first physical downlink control channel (PDCCH) occasion after the DCI field is detected and the RAPID preamble index or the WUS preamble index matches a preamble index selected at the UE for transmission. The number of monitoring occasions (monitoringOccasions) can comprise: {1, 2, 4, 8, . . . N}, that is configured in the DCI field, where N is a positive integer multiple of 2; or the monitoring window (monitoringWindow) can comprise: {1, 2, 4, 5, 10, 20 . . . T] in slots or milliseconds, that is configured in the DCI field, where T is a positive integer.

The UE 106 can be configured to follow the number of monitoring occasions when it is configured or the monitoring window when it is configured, otherwise it is up to an implementation by the UE to monitor the SS #0. When the DCI field for the SSB index or the SSB-PositionsInBurst is not included, then: the one or more processors are configured to assume that the on-demand SIB1 will be sent on a same SSB that sends the WUS response; or which PDCCH occasions are monitored at the UE is up to UE implementation. When the DCI field for the SSB index is included, the one or more processers are configured to follow an indication to monitor a corresponding PDCCH occasion and the SIB1 is received at the UE in the SSB.

When the DCI field indicating whether the downlink assignment field is configured comprises: 0: no downlink assignment field; or 1: there will be a downlink assignment field, in a scheduled physical downlink shared channel, and an uplink grant will be configured for the UE to send a confirmation message of successful reception of the SIB1.

In some embodiments, the method 2000 can further comprise decoding, at the UE, a medium access control sub-physical data unit (MAC sub-PDU) that includes the WUR in a MAC WUR. The MAC WUR can include a configuration for a control resource set #0 (CORESET #0) and a search space #0 (SS #0). The MAC sub-PDU can further comprise a MAC sub-header with a Random Access Preamble identification (RAPID) preamble index or a WUS preamble index. The MAC WUR can further comprise a monitoring occasion or a monitoring window field. The UE can be configured to follow an indication for a monitoring duration of the monitoring occasion or the monitoring window when the monitoring occasion or the monitoring window field is configured, or the UE is configured determine a monitoring implementation when the monitoring window field is not configured.

The MAC WUR can further comprise a synchronization signal physical broadcast channel index (SSB index); and an SSB bitmap; or a group bitmap to indicate SSBs that will be associated with the on-demand SIB 1 for the UE to monitor. When the SSB index or SSB bitmap is not configured, the UE can be configured to: identify that the on-demand SIB 1 is sent from the NES cell associated with the WUR; or select physical downlink shared channel (PDCCH) occasions to monitor based on UE implementation.

In some embodiments, the method 2000 can further comprise decoding, at the UE, the on-demand SIB1 in a scheduled transport block (TB) of a physical downlink control channel (PDCCH); or decoding a medium access control (MAC) WUR that is configured to carry the on-demand SIB 1.

In some embodiments, the method 2000 can further comprise decoding, at the UE, a downlink control information (DCI) field to indicate that the on-demand SIB1 is a one-time transmission or a periodic broadcast SIB1. The DCI field can comprise: 0: the periodic broadcast of the SIB1; or 1: the one-time transmission of the on-demand SIB1.

In some embodiments, an apparatus can be configured to cause a user equipment (UE) to perform any of the operations of the method 2000.

In some embodiments, a user equipment (UE) can be configured to perform any of the operations described herein.

In some embodiments, a next generation node B (gNB) can be configured to perform any of the operations described herein.

In some embodiments, a computer program product is disclosed, comprising computer instructions which, when executed by one or more processors, perform any of the operations described herein.

Embodiments of the present disclosure may be realized in any of various forms. For example, some embodiments may be realized as a computer-implemented method, a computer readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus of a user equipment (UE), the apparatus comprising:
one or more processors, coupled to a memory, configured to:
decode, at the UE, a wakeup signal (WUS) configuration message received from an anchor cell attached to the UE;
encode, at the UE a WUS message for transmission to a network energy saving (NES) cell to wake up an on-demand system information block 1 (SIB1) at the NES cell;
decode, at the UE, a WUS response (WUR) message from the NES cell; and
decode, at the UE, the on-demand SIB1 from the NES cell, based on information received in the WUR message.

2. The apparatus of claim 1, wherein the WUS configuration message comprises:
time, frequency, and sequence resources for the UE to transmit the WUS message; and
configuration information for a WUS-response window, a WUS-response control resource set (CORESET), and WUS-response search space.

3. The apparatus of claim 1, wherein the one or more processors are further configured to:
decode, at the UE, one or more on-demand SIB1 WUS preambles associated with the on-demand SIB1.

4. The apparatus of claim 1, wherein the one or more processors are further configured to:
start a physical downlink control channel (PDCCH) monitoring window, after sending the WUS message, to monitor the WUS response.

5. The apparatus of claim 1, wherein the one or more processors are further configured to:
decode, at the UE, a configuration for a control resource set #0 (CORESET #0) and a search space #0 (SS #0) in downlink control information (DCI) of the WUR message received from the NES cell; or
decode, at the UE, downlink control information (DCI) in a DCI format 1 x, where x is zero or a positive integer, and the DCI includes a scrambled cyclic redundancy check (CRC).

6. (canceled)

7. The apparatus of claim 5, wherein the CRC is scrambled with a random access (RA) radio network temporary identifier (RA-RNTI) or a WUS-RNTI.

8. The apparatus of claim 6, wherein the DCI comprises a DCI field including one or more of:
a Random Access Preamble identification (RAPID) preamble index or a WUS preamble index; or
a physical downlink control channel (PDCCH) configuration on demand SIB1 (PDCCH-ConfigOnDemandSIB1); or
reserved bits; or
a field indicating a number of occasions or duration for the UE to monitor search space #0 (SS #0); or
a field containing a synchronization signal physical broadcast channel index (SSB index) or an SSB positions in burst (SSB-PositionsInBurst); or
a field indicating whether a downlink assignment field is configured.

9. The apparatus of claim 8, wherein the one or more processors are further configured to start monitoring the DCI field with a CRC scrambled by a system information (SI) RNTI in a search space #0 (SS #0) from a first physical downlink control channel (PDCCH) occasion after the DCI field is detected and the RAPID preamble index or the WUS preamble index matches a preamble index selected at the UE for transmission.

10. The apparatus of claim 8, wherein:
the number of monitoring occasions (monitoringOccasions) comprises: {1, 2, 4, 8, . . . N}, that is configured in the DCI field, where N is a positive integer multiple of 2; or
a monitoring window (monitoring Window) comprises: {1, 2, 4, 5, 10, 20 . . . T] in slots or milliseconds, that is configured in the DCI field, where T is a positive integer.

11. The apparatus of claim 10, wherein the UE is configured to follow the number of monitoring occasions when it is configured or the monitoring window when it is configured, otherwise it is up to an implementation by the UE to monitor the SS #0.

12. The apparatus of claim 8, wherein when the DCI field for the SSB index or the SSB-PositionsInBurst is not included, then:
the one or more processors are configured to assume that the on-demand SIB 1 will be sent on a same SSB that sends the WUS response; or
which PDCCH occasions are monitored at the UE is up to UE implementation.

13. The apparatus of claim 8, wherein when the DCI field for the SSB index is included, the one or more processors are configured to follow an indication to monitor a corresponding PDCCH occasion and the SIB1 is received at the UE in the SSB.

14. The apparatus of claim 8, wherein when the DCI field indicating whether the downlink assignment field is configured comprises:
0: no downlink assignment field; or
1: there will be a downlink assignment field, in a scheduled physical downlink shared channel, and an uplink grant will be configured for the UE to send a confirmation message of successful reception of the one-demand SIB1.

15-22. (canceled)

23. The apparatus of claim 1 wherein the one or more processors are further configured to:
decode, at the UE, a downlink control information (DCI) field to indicate that the on-demand SIB1 is a one-time transmission or a periodic broadcast SIB1.

24. The apparatus of claim 23, wherein the DCI field comprises:
0: the periodic broadcast of the SIB1; or
1: the one-time transmission of the on-demand SIB1.

25. A method of triggering an on-demand system information block 1 (SIB1) transmission to a user equipment (UE), comprising:
decoding, at the UE, a wakeup signal (WUS) configuration message received from an anchor cell attached to the UE;
encoding, at the UE a WUS message for transmission to a network energy saving (NES) cell to wake up an on-demand system information block 1 (SIB1) at the NES cell;
decoding, at the UE, a WUS response (WUR) message from the NES cell; and
decoding, at the UE, the on-demand SIB1 from the NES cell, based on information received in the WUR message.

26. The method of claim 25, wherein the WUS configuration message comprises:
time, frequency, and sequence resources for the UE to transmit the WUS message; and
configuration information for a WUS-response window, a WUS-response control resource set (CORESET), and WUS-response search space.

27. (canceled)

28. The method of claim 25, wherein the method further comprises:
starting a physical downlink control channel (PDCCH) monitoring window, after sending the WUS message, to monitor the WUS response.

29. The method of claim 25, wherein the method further comprises:
decoding, at the UE, a configuration for a control resource set #0 (CORESET #0) and a search space #0 (SS #0) in downlink control information (DCI) of the WUR message received from the NES cell.

30. (canceled)

31. (canceled)

32. The method of claim 30, further comprising:
decoding, at the UE, downlink control information (DCI) in a DCI format 1 x, where x is zero or a positive integer, and the DCI includes a scrambled cyclic redundancy check (CRC), wherein the DCI comprises a DCI field including one or more of:
a Random Access Preamble identification (RAPID) preamble index or a WUS preamble index; or
a physical downlink control channel (PDCCH) configuration on demand SIB1 (PDCCH-ConfigOnDemandSIB1); or
reserved bits; or
a field indicating a number of occasions or duration for the UE to monitor search space #0 (SS #0); or
a field containing a synchronization signal physical broadcast channel index (SSB index) or an SSB positions in burst (SSB-PositionsInBurst); or
a field indicating whether a downlink assignment field is configured.

33-52. (canceled)
